(19) United States
(12) Patent Application Publication
(10) Pub. No.: US 2026/0332685 A1
(43) Pub. Date: Oct. 22, 2026

(54) PARAMETER-BASED ENCODING PROCEDURE SELECTION

(71) Applicant: Lenovo (United States) Inc., Morrisville, NC (US)

(72) Inventors: Vahid Pourahmadi, München (DE); Tapisha Soni, Munich (DE); Joachim Löhr, Wiesbaden (DE)

(73) Assignee: Lenovo (United States) Inc., Morrisville, NC (US)

(21) Appl. No.: 19/272,714

(22) Filed: Jul. 17, 2025

(51) Int. Cl. H04L 69/22; H04L 1/00; H04W 72/1263

(52) U.S. Cl. CPC H04L 69/22; H04L 1/0009; H04W 72/1263

(57) ABSTRACT

Various aspects of the present disclosure relate to parameter-based encoding procedure selection. An apparatus, such as a user equipment (UE), receives one or more parameter sets, where each parameter set may include one or more parameters for measurement and a set of multiple encoding procedures. An encoding procedure may represent a neural network (NN)-based model or a quantization scheme. The UE selects an encoding procedure of the set of encoding procedures based on measurements of the one or more parameters, and the UE may transmit an indication of the selected encoding procedure. A network equipment (NE) may receive the indication and determine a decoding procedure based on the selected encoding procedure.

### TECHNICAL FIELD

The present disclosure relates to wireless communications, and more specifically to parameter-based encoding procedure selection.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based on.” Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may be configured to, capable of, or operable to receive one or more parameter sets, where each parameter set includes one or more parameters for measurement and a set of multiple encoding procedures; select an encoding procedure of the set of multiple encoding procedures based on measurements of the one or more parameters; and transmit an indication of the selected encoding procedure.

A processor (e.g., a standalone processor chipset, or a component of a UE) for wireless communication is described. The processor may be configured to, capable of, or operable to perform one or more operations as described herein. For example, the processor may be configured to, capable of, or operable to receive one or more parameter sets, where each parameter set includes one or more parameters for measurement and a set of multiple encoding procedures; select an encoding procedure of the set of multiple encoding procedures based on measurements of the one or more parameters; and transmit an indication of the selected encoding procedure.

A method performed or performable by a UE for wireless communication is described. The method may include receiving one or more parameter sets, where each parameter set includes one or more parameters for measurement and a set of multiple encoding procedures; selecting an encoding procedure of the set of multiple encoding procedures based on measurements of the one or more parameters; and transmitting an indication of the selected encoding procedure.

In some implementations of the UE, the processor, and the method described herein, the UE, the processor, and the method may further be configured to, capable of, operable to, performed to, or performable to generate feedback data based on the measurements and the selected encoding procedure.

In some implementations of the UE, the processor, and the method described herein, the UE, the processor, and the method may further be configured to, capable of, operable to, performed to, or performable to receive an indication of a set of resources; and transmit the indication of the selected encoding procedure and the feedback data on at least one resource of the set of resources. In some implementations of the UE, the processor, and the method described herein, the set of resources is a same set of resources for multiple parameter sets.

In some implementations of the UE, the processor, and the method described herein, a quantity of resources in the set of resources is based on a largest quantity of resources needed for transmission of the feedback data among the set of multiple encoding procedures. In some implementations of the UE, the processor, and the method described herein, the UE, the processor, and the method may further be configured to, capable of, operable to, performed to, or performable to transmit an indication of a quantity of resources from the set of resources used for transmission of the feedback data.

In some implementations of the UE, the processor, and the method described herein, the UE, the processor, and the method may further be configured to, capable of, operable to, performed to, or performable to multiplex the feedback data and other data for transmission on the set of resources. In some implementations of the UE, the processor, and the method described herein, a parameter set of the one or more parameter sets corresponds to an encoding procedure of the set of multiple encoding procedures, and where the at least one processor is further operable to cause the UE to determine a group of encoding procedures that includes the encoding procedure based on an identifier (ID) of the encoding procedure.

In some implementations of the UE, the processor, and the method described herein, each encoding procedure of the set of multiple encoding procedures corresponds to an ID, and where the indication of the selected encoding procedure includes an ID corresponding to the selected encoding procedure.

In some implementations of the UE, the processor, and the method described herein, a parameter set of the one or more parameter sets corresponds to an encoding procedure of the set of multiple encoding procedures, and where the parameter set further includes a field that indicates a group of encoding procedures that includes the encoding procedure. In some implementations of the UE, the processor, and the method described herein, the one or more parameter sets includes one parameter set that indicates the set of multiple encoding procedures.

In some implementations of the UE, the processor, and the method described herein, the UE, the processor, and the method may further be configured to, capable of, operable to, performed to, or performable to select the encoding procedure based on a determination of one or more parameters excluded from the one or more parameter sets. In some implementations of the UE, the processor, and the method described herein, each encoding procedure of the set of multiple encoding procedures represent a neural network (NN)-based model or a quantization scheme.

An NE (e.g., a base station) for wireless communication is described. The NE may be configured to, capable of, or operable to perform one or more operations as described herein. For example, the NE may be configured to, capable of, or operable to transmit one or more parameter sets, where each parameter set includes one or more parameters for measurement by a UE and a set of multiple encoding procedures; receive an indication of a selected encoding procedure of the set of multiple encoding procedures; and determine a decoding procedure based on the selected encoding procedure.

A processor (e.g., a standalone processor chipset, or a component of a NE) for wireless communication is described. The processor may be configured to, capable of, or operable to perform one or more operations as described herein. For example, the processor may be configured to, capable of, or operable to transmit one or more parameter sets, where each parameter set includes one or more parameters for measurement by a UE and a set of multiple encoding procedures; receive an indication of a selected encoding procedure of the set of multiple encoding procedures; and determine a decoding procedure based on the selected encoding procedure.

A method performed or performable by an NE (e.g., a base station) for wireless communication is described. The method may include transmitting one or more parameter sets, where each parameter set includes one or more parameters for measurement by a UE and a set of multiple encoding procedures; receiving an indication of a selected encoding procedure of the set of multiple encoding procedures; and determining a decoding procedure based on the selected encoding procedure.

In some implementations of the NE, the processor, and the method described herein, the NE, the processor, and the method may further be configured to, capable of, operable to, performed to, or performable to transmit an indication of a set of resources; receive the indication of the selected encoding procedure and feedback data on at least one resource of the set of resources; and decode the feedback data based on the decoding procedure.

In some implementations of the NE, the processor, and the method described herein, the set of resources is a same set of resources for multiple parameter sets. In some implementations of the NE, the processor, and the method described herein, a quantity of resources in the set of resources is based on a largest quantity of resources needed for transmission of the feedback data among the set of multiple encoding procedures.

In some implementations of the NE, the processor, and the method described herein, the NE, the processor, and the method may further be configured to, capable of, operable to, performed to, or performable to receive an indication of a quantity of resources from the set of resources used for transmission of the feedback data.

In some implementations of the NE, the processor, and the method described herein, the NE, the processor, and the method may further be configured to, capable of, operable to, performed to, or performable to de-multiplex the feedback data and other data received on the set of resources based on the quantity of resources.

In some implementations of the NE, the processor, and the method described herein, each encoding procedure of the set of multiple encoding procedures represent an NN-based model or a quantization scheme. In some implementations of the NE, the processor, and the method described herein, a parameter set of the one or more parameter sets corresponds to an encoding procedure of the set of multiple encoding procedures and where a group of encoding procedures that includes the encoding procedure is indicated based on an ID of the encoding procedure.

In some implementations of the NE, the processor, and the method described herein, each encoding procedure of the set of multiple encoding procedures corresponds to an ID, and where the indication of the selected encoding procedure includes an ID corresponding to the selected encoding procedure. In some implementations of the NE, the processor, and the method described herein, a parameter set of the one or more parameter sets corresponds to an encoding procedure of the set of multiple encoding procedures, and where the parameter set further includes a field that indicates a group of encoding procedures that includes the encoding procedure. In some implementations of the NE, the processor, and the method described herein, the one or more parameter sets includes one parameter set that indicates the set of multiple encoding procedures.

### BRIEF DESCRIPTION OF THE DRAWINGS

FIG. 1 illustrates an example of a wireless communications system in accordance with aspects of the present disclosure.

FIG. 2 illustrates an example of a wireless network in accordance with aspects of the present disclosure.

FIG. 3 illustrates an example of a two-sided model in accordance with aspects of the present disclosure.

FIGS. 4A through 4H, 5A, and 5B illustrate examples of information elements (IEs) in accordance with aspects of the present disclosure.

FIG. 6 illustrates an example of a model, in accordance with aspects of the present disclosure.

FIG. 7 illustrates an example of a UE in accordance with aspects of the present disclosure.

FIG. 8 illustrates an example of a processor in accordance with aspects of the present disclosure.

FIG. 9 illustrates an example of an NE in accordance with aspects of the present disclosure.

FIG. 10 illustrates a flowchart of a method performed by a UE in accordance with aspects of the present disclosure.

FIG. 11 illustrates a flowchart of a method performed by an NE in accordance with aspects of the present disclosure.

### DETAILED DESCRIPTION

In a wireless communications system, a UE and an NE (e.g., a base station, gNB) may support wireless communication (e.g., reception and/or transmission of wireless communication) using time-frequency resources. In some examples, the UE and the NE may support artificial intelligence (AI)/machine learning (ML) models for numerous applications such as the generation, encoding, and decoding of feedback data. The UE and the NE may support two-sided model, where the UE supports a first part (i.e., part 1) of the model, which may be an encoder model, and the NE supports a second part (i.e., part 2) of the model, which may be a decoder model. In some implementations, the NE should know what model the UE used to generate feedback data for proper decoding. To obtain this knowledge, the NE may configure the UE to use a particular encoder model so that the NE knows to use a corresponding decoder model. However, in some cases, the NE may be unable to pre-select a model that the UE is actively using. For example, the UE and the NE may support two different two-sided models for sending reports for channels of rank 1 and rank 2. If the UE is actively using one of the models, the NE may not know which one and therefore may not know whether to use its corresponding decoder model for channels of rank 1 or rank 2.

Aspects of the present disclosure are described in the context of a wireless communications system, and include implementations that provide for parameter-based encoding procedure selection to facilitate model alignment between the UE and the NE. The UE may receive one or more parameter sets from the NE, where each parameter set may include one or more parameters for measurement and a set of multiple encoding procedures. An encoding procedure may represent an encoder model which may be an NN-based model or a quantization scheme, and only one encoding procedures of the set of multiple encoding procedures may be activated at a given time. The UE may select an encoding procedure of the set of encoding procedures based on measurements of the one or more parameters, and the UE may transmit an indication of the selected encoding procedure to the NE. Based on the selected encoding procedure, the NE may select a decoding procedure (e.g., a decoder model). In this way, the NE may select an appropriate two-sided model for decoding feedback data generated by the UE, which may improve signaling throughput, reduce latency, and reduce overhead, among other improvements.

In some implementations, to facilitate indication of the selected encoding procedure, the NE may configure multiple reporting schemes, where each reporting scheme may be associated with different encoding procedures and include an ID, such as a report-group-Id. In this way, the NE may configure multiple configurations to have the same reporting resources and configure the UE to transmit a report for only one of the configurations with the same report-group-Id. In some implementations, each encoding procedure may be associated with an ID that indicates a group of encoding procedures. Additionally, the described techniques may support a variable reporting size. Additionally, or alternatively, the NE may configure a single reporting scheme associated with multiple encoding procedures.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

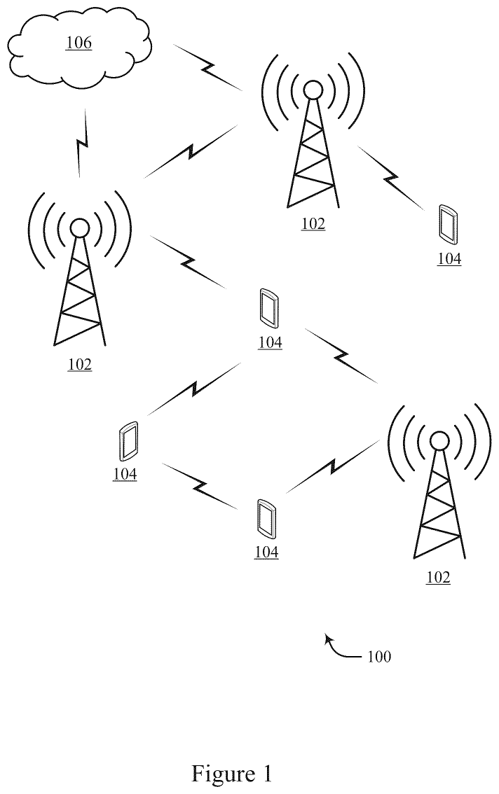

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a UE 104 receives one or more parameter sets from the NE 102, where each parameter set may include one or more parameters for measurement and a set of multiple encoding procedures. An encoding procedure may represent an encoder model which may be an NN-based model or a quantization scheme. The UE 104 may select an encoding procedure of the set of encoding procedures based on measurements of the one or more parameters, and the UE 104 may transmit an indication of the selected encoding procedure to the NE 102. Based on the selected encoding procedure, the NE 102 may select a decoding procedure (e.g., a decoder model). In this way, the NE 102 may select an appropriate two-sided model for decoding feedback data generated by the UE 104, which may improve signaling throughput, reduce latency, and reduce overhead, among other improvements

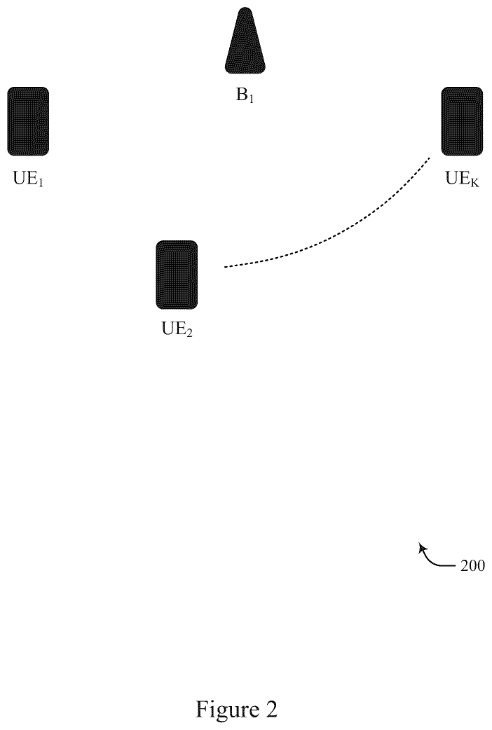

FIG. 2 illustrates an example of a wireless network 200 in accordance with aspects of the present disclosure. The wireless network 200 may include a UE₁, a UE₂, and a UE_{K}, which may be examples of UEs 104 of FIG. 1. In addition, the wireless network may include a node B₁, which may be an example of an NE 102 of FIG. 1 (e.g., a base station, a gNB).

In the wireless network 200, the NE 102 B₁ may be equipped with M antennas and K UEs 104, including UE₁, UE₂, . . . , and UE_{K}. Each UE 104 may have N antennas.

$${H}_{l}^{k} ( t )$$

denotes a downlink channel at a time t over frequency band l, l∈{1, 2, . . . , L} between B₁ and UE_{K}.

$${H}_{l}^{k} ( t )$$

may be a matrix of size N×M with complex entries such as

$${H}_{l}^{k} ( t ) ∈ {ℂ}^{N \times M} .$$

At time t and frequency band l, it may be assumed that the NE 102 B₁ wants to transmit a message

$${x}_{l}^{k} ( t )$$

to the UE_{K}, where k={1, 2, . . . , K} and

$${w}_{l}^{k} ( t ) ∈ {ℂ}^{M \times 1}$$

is used as a precoding vector. The received signal at Uₖ,

$${y}_{l}^{k} ( t ) ,$$

can be written as

$${y}_{l}^{k} ( t ) = {H}_{l}^{k} ( t ) {w}_{l}^{k} ( t ) {x}_{l}^{k} ( t ) + {n}_{l}^{k} ( t ) ,$$

where

$${n}_{l}^{k} ( t )$$

may represent a noise vector at the receiver.

To improve the achievable rate of the link, the NE 102 B₁ may select a

$${w}_{l}^{k} ( t )$$

that maximizes a received signal-to-noise ratio (SNR) or a received signal-interference-to-noise ratio (SINR) (in case of muti-user transmission). Several schemes may be used for the selection of

$${w}_{l}^{k} ( t ) ,$$

where most techniques rely on the NE 102 B₁ having some knowledge about

$${H}_{l}^{k} ( t ) .$$

In some examples, the NE 102 B₁ may get knowledge of

$${H}_{l}^{k} ( t )$$

by direct measurement of the channel (e.g., in a time division duplex (TDD) mode and assuming reciprocity of the channel), or indirectly using the information that a UE 104 transmits to the NE 102 B₁ (e.g., in an frequency division duplex (FDD) mode). In the latter case, the UE 104 may require a large amount of feedback to send accurate information about

$${H}_{l}^{k} ( t ) .$$

This becomes particularly important when there is a large number of antennas or/and large frequency bands. While described in the context of a single time slot, the described techniques may be further extended to the cases with more than a single time slot. Without loss of generality, therefore,

$${H}_{l}^{k} ( t )$$

is denoted for simplicity using

$${H}_{l}^{k} .$$

Additionally, H^{k} represents a matrix of size N×M×L, which is composed by stacking Hₗ^{k} for all frequency bands, that is, the entries at H^{k}[n, m, l] is equal to

$${H}_{l}^{k} [ n , m ] .$$

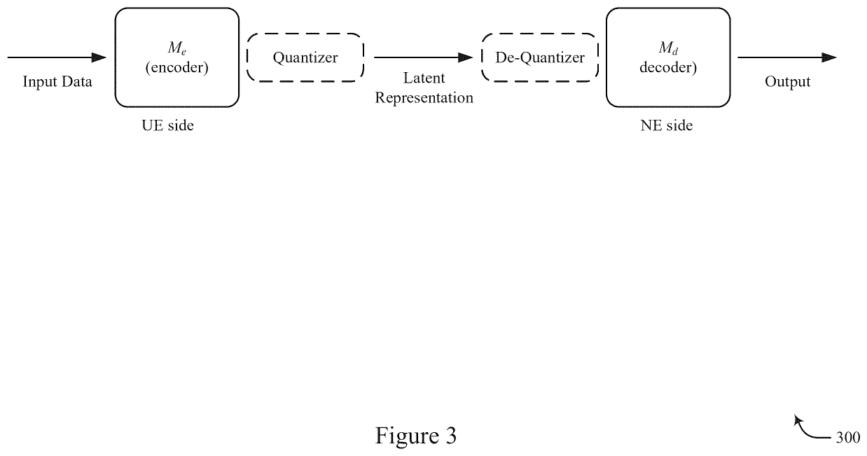

Therefore, to transmit complete information regarding H^{k}, the UE may transmit feedback information about N×M×L complex numbers to the NE 102 B₁. Systems may use various methods to reduce the rate of required feedback. For example, some systems may use quantization of the measured channel based on a codebook. Alternatively, some systems may use AI-based methods, which are described in FIG. 3.

FIG. 3 illustrates an example of a two-sided model 300 in accordance with aspects of the present disclosure. The example of FIG. 3 illustrates a high-level structure of the two-sided model 300 with two parts, where a first part is deployed at a UE side and a second part is deployed at an NE (e.g., gNB) side. The UE side may be referred to as Mₑ, an encoding model or an encoder, and the NE side may be referred to as M_{d}, a decoding model or a decoder. The input data for the two-sided model 300 may be based on a channel measurement (e.g., a raw channel measurement) or eigenvectors associated with a measured channel.

As described in FIG. 2, the two-sided model 300 may be an example of an AI-based method used to reduce the rate of required feedback between an NE 102 and a UE 104 in a wireless network. In the two-sided model 300, the UE side and the NE side may be NN-based, meaning that each side includes one or more NN blocks trained using data-driven approaches. The UE side, or the encoder, may be responsible for computing a latent representation of input data (e.g., what needs to be transferred to the NE) with as few bits as possible. Receiving what the UE side transmitted, the NE side, or the decoder, may reconstruct the information intended to be transmitted to the NE 102 using the received message.

In some implementations, the two-sided model 300 may support an exemplary AI-based channel state information (CSI) feedback use case which may use a first part of an AI model to compress CSI at the UE side and transmit the compressed data, and a second part of an AI model to recover the CSI at the NE side. Although CSI feedback is an exemplary use case for the two-sided model 300, the two-sided model 300 is not limited to this particular use case and may be applicable to any case in which ML modules may be used to generate a latent representation of data at one node for transmission to another node with an optimized quantity of bits. The two-sided model 300 may be utilized to make the quantity of transmitted bits dependent on the content of the input data.

In some examples of CSI reporting, a UE 104 may transmit information to an NE 102 to inform the NE 102 about communication parameters, including a channel quality indicator (CQI), a rank indicator (RI), and a precoding matrix indicator (PMI). In particular, the PMI may be reported to enable downlink beamforming and interference management by indicating suitable spatial precoding vectors across frequency. CSI codebooks may provide enhanced spatial resolution and exploit channel sparsity to reduce feedback overhead via angle-frequency domain compression. The AI-based counterpart may further reduce the overhead by developing models that are fine-tuned based on the CSI data statistics.

The structure of the two-sided model 300 may vary depending on a particular scheme or design. In general, the encoder may include several layers, and the output is or may be converted to a vector z with a particular size, d. Although the design is such that d may be smaller than the size of the original input data, the output may be unsuitable for transmission because it is composed of d real-valued numbers. To reduce the associated overhead, the vector z may be quantized using scalar or vector quantizers, and the resulted quantized version may be transmitted to the NE 102. The NE 102 may receive these quantized data, dequantize the data as applicable, and use the data as the input of the decoder at the NE side. In some examples, the quantizer and the de-quantizer may be considered as part of the encoder and the decoder, respectively. Alternatively, the quantizer and the de-quantizer may be considered as separate components after the encoder and before the decoder, respectively. With such a design for the two-sided model 300, the total quantity of feedback bits required or transmission of information about each channel measurement may be equal to the quantity of bits required for transmission of the quantized data.

After the encoder and decoder and the associated quantizer and de-quantizer are designed and trained, the quantity of feedback bits may be fixed for all different input samples. This is because the output dimension of the employed AI/ML models may be fixed, and so assuming a predetermined quantizer, the quantity of feedback bits therefore may also become fixed. In contrast, for some CSI-codebooks (e.g., Type-2 codebooks), the UE 104 may determine to send coefficients with significant values. Therefore, even assigned resources for uplink may be fixed, and the actual quantity of resources occupied by a CSI report may be less and may change from one CSI report to another. CSI reports may have two parts. As a length of a CSI report may change, the length of a first part of the CSI report may be known, and the UE 104 may use the first part to indicate to the NE 102 how many bits (after removing small coefficients) may be transmitted in a second part of the CSI report.

In some other implementations, the quantity of required feedback bits may depend on a number of layers (e.g., precoders) that the UE 104 sends to the NE 102. For example, based on the rank of a particular channel realization, the UE may decide to transmit information only for a single layer or in other cases, for two or more layers. The number of required CSI-feedback bits may differ in these different cases. In the case of AI-based CSI compression, different models (e.g., AI/ML models) may generate data for the case of single-layer feedback and two-layer feedback.

In some examples, the NE 102 and the UE 104 may be synchronized on an AI-model that the UE 104 is using for reporting information to the NE 102. For example, for the use case of AI-based beam management, the NE 102 may transmit a set of configurations or a set of parameters to the UE 104, which the UE 104 may use to determine what models may be acceptable for the NE 102. Based on the configurations or parameters and the availability of the models at the UE side, the UE 104 may report the applicable models to the NE 102.

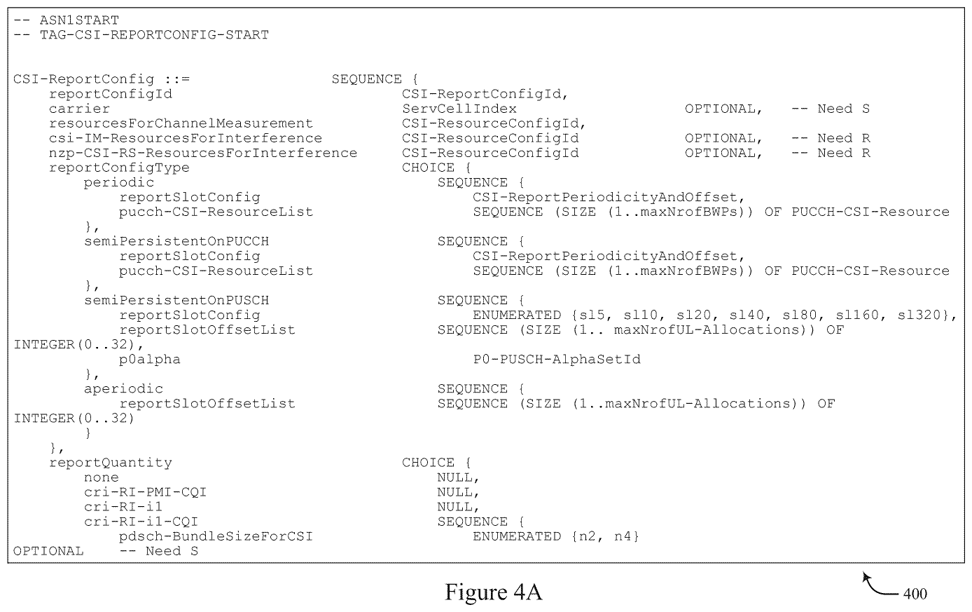

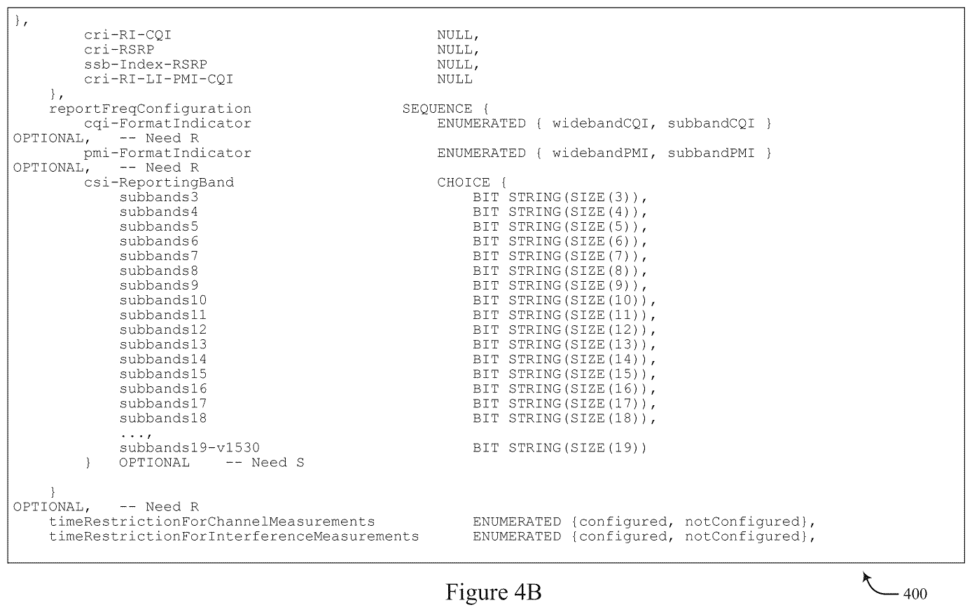

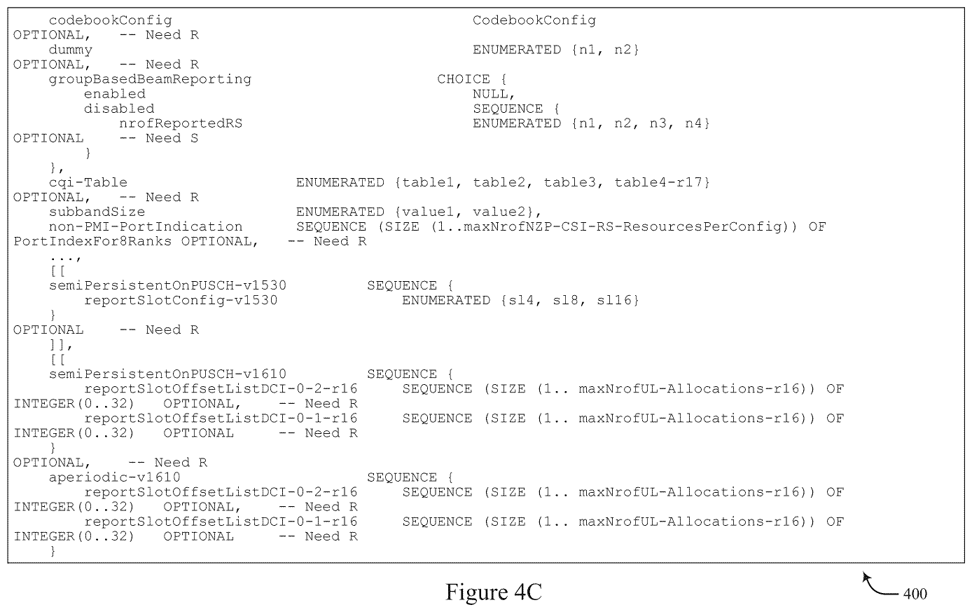

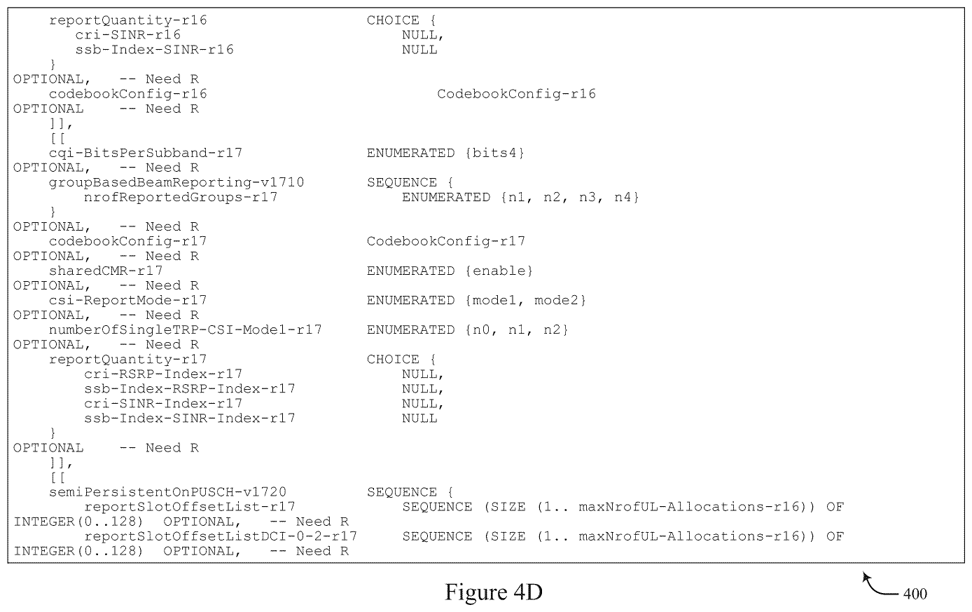

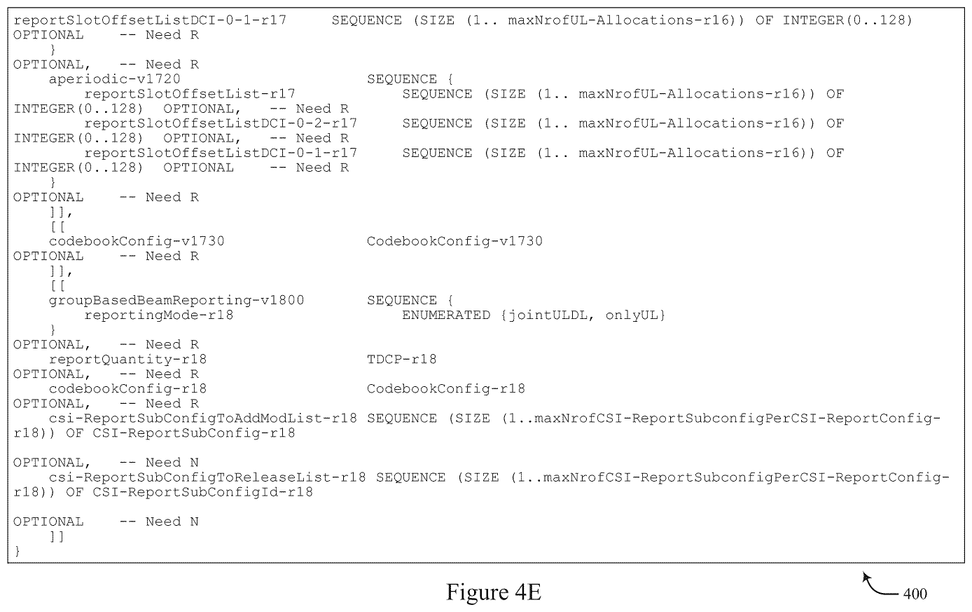

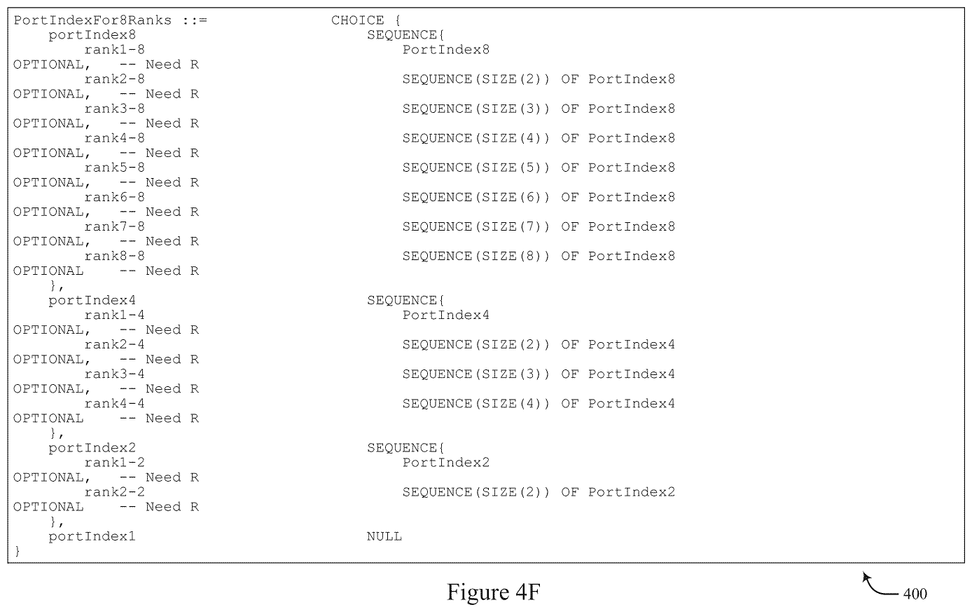

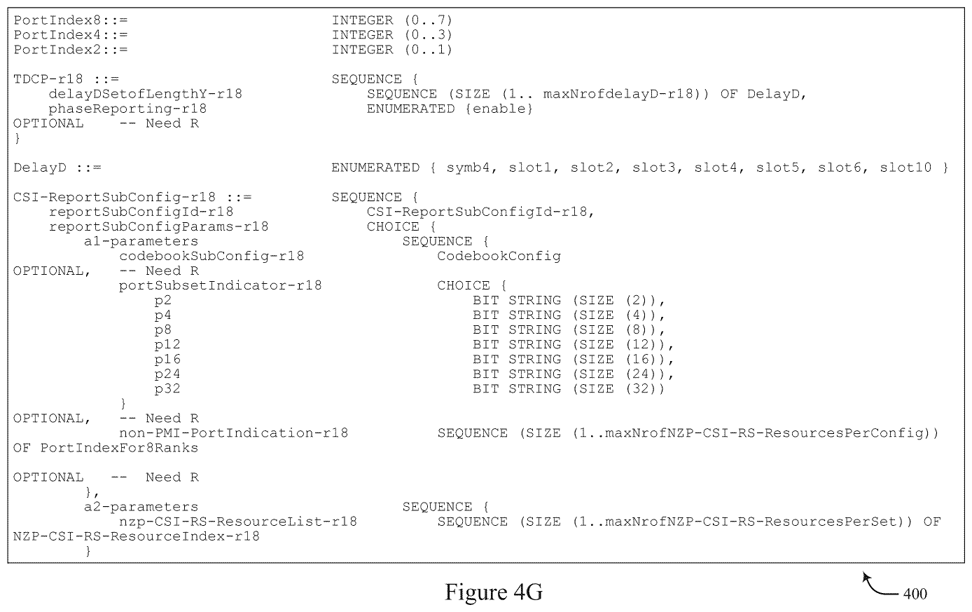

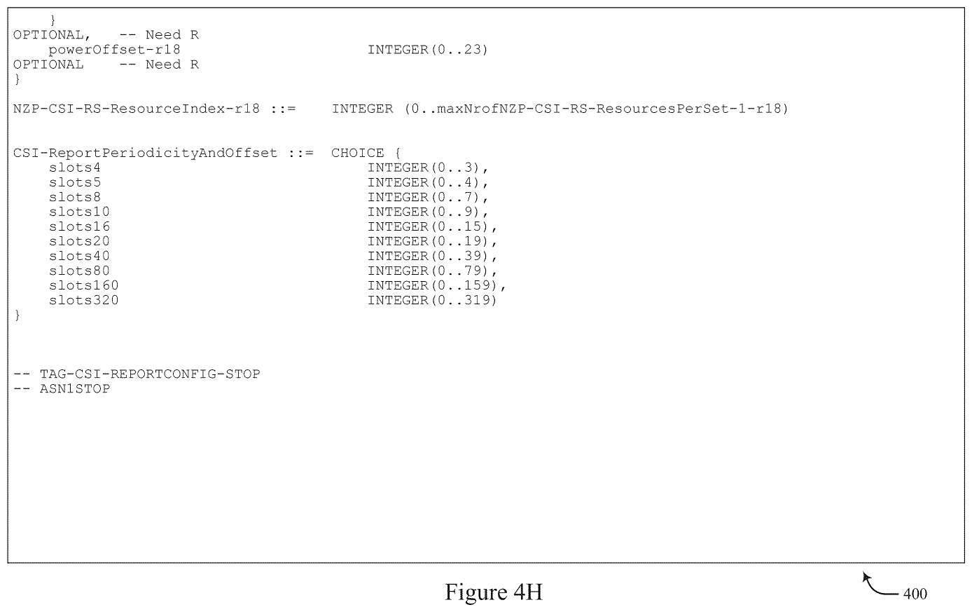

As described with reference to FIGS. 4A through 4H, a CSI-ReportConfig IE may be used to configure a periodic, semi-persistent report, or aperiodic report sent via a physical uplink control channel (PUCCH) or a physical uplink shared channel (PUSCH). The CSI-ReportConfig IE may include a reportConfigId parameter, where each reportConfigId may represent a configuration regarding a particular AI-based model (e.g., for a beam management use case, the configuration may include associatedIDforSetA-r19, associatedIDforSetB-r19, and resourcesForSetA-r19), including a measurement and reporting configuration. The UE 104 may report the appliable or inapplicable reportConfigId using an ApplicabilityReportConfigIdList-r19 message. In response to the message from the UE 104, one of the reportConfigID (e.g., one of the applicable periodic CSI reports for the beam management case) may be considered as activated. Alternatively, the NE 102 itself may activate one of the applicable reportConfigIds indicated by the UE 104.

Activating models in this way may reduce the capability of the UE 104 to use different models based on current states of the UE 104 or based on UE 104 measurements because it would require the NE 102 to first activate a different model. In addition to required NE 102 permission for model activation, the uplink resources used for AI-based model reporting may differ. For example, the number of required resource elements (REs) for reporting a PMI may differ when the UE 104 wants to report PMIs for two layers or a single layer. So, if the UE 104 wants to report two layers, the UE 104 needs to use another CSI-ReportConfig configuration that supports the required uplink resources for reporting of the two layers. The techniques described herein enable the UE 104 to apply different models for particular tasks that may require different numbers of resources for feedback reporting.

FIGS. 4A through 4H illustrate an example of an IE 400 in accordance with aspects of the present disclosure. The IE 400 may be an example of a CSI-ReportConfig IE, which may be used to configure a periodic or semi-persistent report sent on PUCCH on a cell in which the CSI-ReportConfig IE is included, or to configure a semi-persistent or aperiodic report sent on PUSCH triggered by downlink control information (DCI) and received on a cell in which the CSI-ReportConfig IE is included. In the latter case, the cell on which the report is sent is determined by the received DCI.

CSI reporting may enable a UE 104 to provide information about channel conditions to an NE 102. The NE 102 may use the information to optimize link performance, including adaptive modulation and coding, link adaptation, and beamforming. The UE 104 may measure and report CSI measurements for CSI reference signals (CSI-RSs) configured by the NE 102 by using a CSI measurement and reporting framework. The NE 102 may configure the UE 104 with a CSI reporting configuration, which includes a type and a format of CSI feedback and a periodicity of the reporting. The UE 104 may use the CSI-ReportConfig IE depicted as the IE 400 to configure various parameters for CSI reporting. In addition, the UE 104 may use a CSI-ResourceConfig IE for measurement.

A reportQuantity parameter in the CSI-ReportConfig IE may indicate the parameters the UE 104 is to measure, such as CSI and Layer 1 (L1)-reference signal received power (RSRP) related quantities. Additionally, the CSI-ReportConfig IE may include measurement resource parameters including CSI-resources and synchronization signal block (SSB) resources. Specifically, the NE 102 may configure CSI-resources that the UE 104 may use for channel measurements, and some measurements may be based on SSBs, which may be useful for beam management and initial access procedures. Additionally, the CSI-ReportConfig IE may specify not only the periodicity of the CSI reporting (e.g., periodic, semi-persistent, or aperiodic), but also a format and content of the CSI reports the UE 104 is expected to send. For example, different report types may include one or more of a component resource indicator (CRI), which indicates a preferred beam or CSI-RS resource, a rank indicator (RI), which suggests a number of spatial layers, a PMI, which recommends a precoding matrix, a channel quality indicator (CQI), which advises on a modulation and coding scheme (MCS), an RSRP, which measures the power of received signals, an SSB index, which indicates which SSB is preferred, a layer indicator (LI), which indicates a mapping between codeword(s) and layer(s) in multi-layer transmissions, or i1, a part of a Type II codebook that represents wideband or subband spatial information. By way of example, these parameters may be used in the CSI-ReportConfig IE to indicate various report types, such as cri-RI-PMI-CQI, cri-RI-i1, cri-RI-i1-CQI, cri-RI-CQI, cri-RSRP, ssb-Index-RSRP, and cri-RI-LI-PMI-CQI.

Additionally, or alternatively, the CSI-ReportConfig IE may include parameters including one or more of pmi-FormatIndicator, csi-ReportingBand, subbandSize, nrofReprtedRS, reportSlotConfig, resourcesForChannelMeasurement, or CSI-ReportPeriodicityAndOffset. The pmi-FormatIndicator parameter may indicate whether the UE 104 is to report a single (e.g., wideband) PMI or multiple (e.g., subband) PMI. The csi-ReportingBand parameter may indicate a contiguous or non-contiguous subset of subbands in a bandwidth part (BWP) for which the UE 104 reports CSI. Each bit in a bit string of this parameter may represent one subband in order of frequency position in the BWP. The right-most bit in the bit string may represent the lowest subband with the lowest frequency position in the BWP. The choice determines the number of subbands (e.g., subbands3 for three subbands, subbands4 for four subbands, and so forth). This field may be absent from the CSI-ReportConfig IE if there are fewer than 24 physical resource blocks (PRBs) (e.g., no subbands), and otherwise may be present in the CSI-ReportConfig IE.

The subbandSize parameter may indicate one of two possible BWP-dependent values for a given subband size. The nrofReportedRS parameter may indicate a number, N, of measured reference signal resources to be reported per report setting in a non-group-based report. N≤Nₘₐₓ, where Nₘₐₓ may be either two or four depending on UE capability. The reportSlotConfig parameter may indicate a periodicity and a slot offset. If a field reportSlotConfig-v1530 is present, the UE 104 may ignore the value provided in reportSlotConfig and use the value provided in reportSlotConfig-v1530. The resourcesForChannelMeasurement parameter may indicate resources for channel measurement. The CSI-ReportPeriodicityAndOffset parameter may be used to configure a periodicity and corresponding offset for the CSI reporting. The periodicity and the offset may be provided in a number of slots. For example, a periodicity value of slots4 may represent a periodicity of four slots, a periodicity value of slots5 may represent a periodicity of five slots, and so forth. In addition, a csi-ResourceConfigId parameter of the CSI-ReportConfig IE may be included in the configuration of the serving cell indicated in a “carrier” field. Additionally, the CSI-ReportConfig 1E may only include non-zero power (NZP)-CSI-RS resources and/or SSB resources, and the CSI-ReportConfig IE may also include a bwp-id parameter that indicates a downlink BWP associated with the reporting.

In some implementations, the CSI-ReportConfig IE may be used for CSI beam management. In such scenarios, the NE 102 may provide the UE 104 one or more CSI-ReportConfig IEs for inference configuration, where an associated ID may be configured in a CSI framework. Additionally, the NE 102 may provide one or more sets of inference-related parameters for applicability reporting (not for inference reporting). For example, the set of inference-related parameters selected for or included in the CSI-ReportConfig IE may include one or more of associatedIDforSetA-r19, associatedIDforSetB-r19 (if available), resourcesForSetA-r19, which indicates Set A related information, resourcesForChannelMeasurement, which indicates Set B related information, reportQuantity-R19, reportConfigType, or nrofReportedPredictedRS-r19, which may include report content related information. Additionally, or alternatively, for some beam management cases, the set of inference-related parameters selected for or included in the CSI-ReportConfig IE may include one or more of time instances-related information for measurements, time instances-related information for prediction, TimeGap-r19, or nrofTimeInstance-r19.

Based on receiving the configuration from the NE 102, the UE 104 may report applicability for the one or more CSI-ReportConfig IEs and/or one or more sets of inference-related parameters. If the UE 104 reports applicability for the one or more CSI-ReportConfig IEs, the NE 102 may activate or trigger applicable aperiodic and semi-persistent CSI reporting based on the applicability reported by the UE 104. Applicable periodic CSI reporting may be considered as activated only if the UE 104 reports the applicability of the corresponding CSI-ReportConfig IE in an RRCReconfigurationComplete message. Additionally, or alternatively, based on receiving the applicability report from the UE 104, the NE 102 may configure a CSI-ReportConfig IE for an inference configuration in an RRCReconfiguration IE, where an associated ID may be configured in a CSI framework. This configuration may be optional if the UE 104 is already configured with the CSI-ReportConfig IE as described herein.

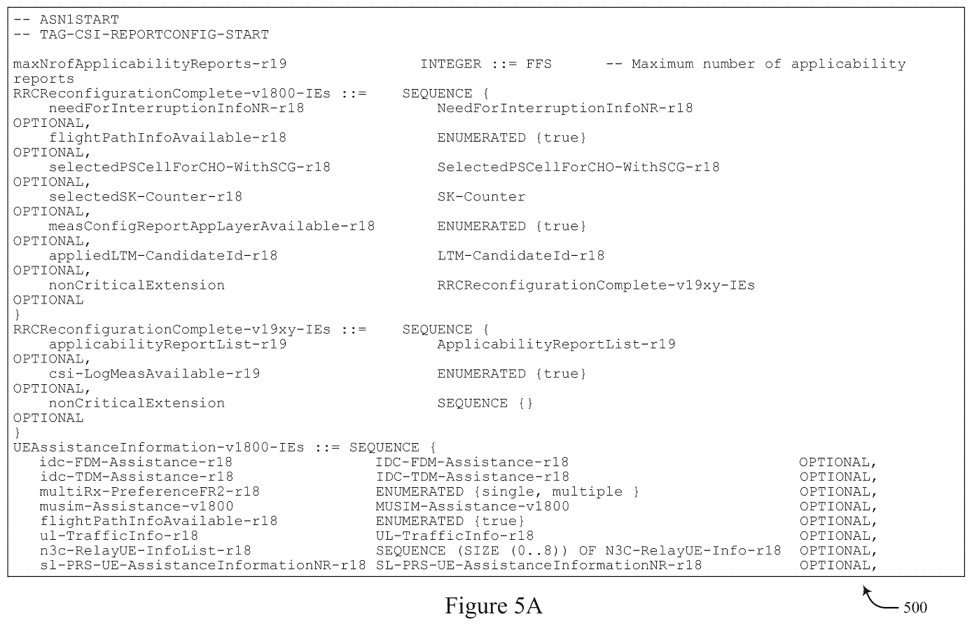

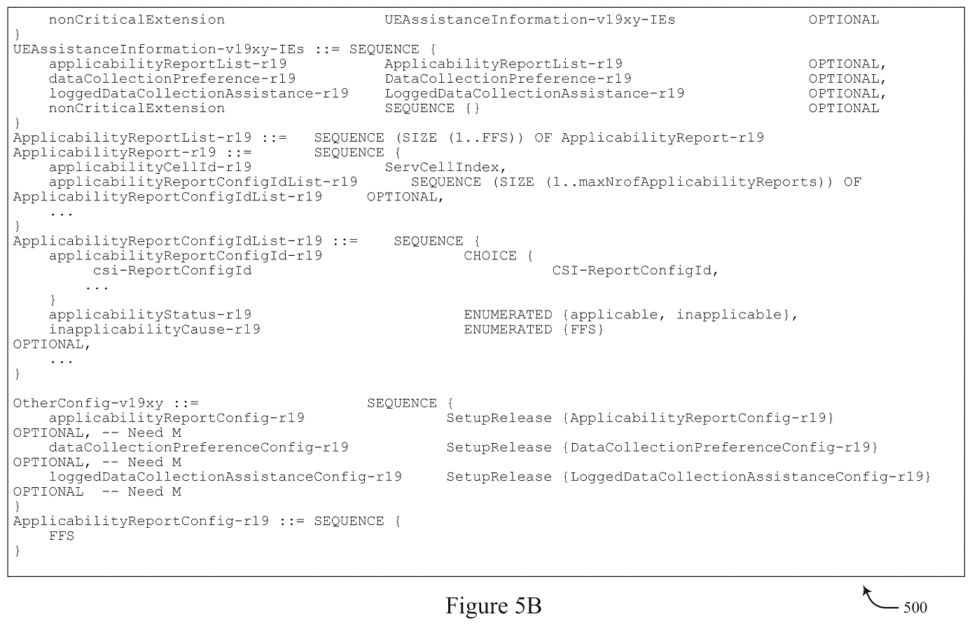

FIGS. 5A and 5B illustrate an example of an IE 500 in accordance with aspects of the present disclosure. The IE 500 may be an example of an RRCReconfigurationComplete IE or message. Based on receiving a full inference configuration from an NE 102, as described with reference to FIGS. 4A through 4H, a UE 104 may transmit an initial applicability report via the RRCReconfigurationComplete IE. Additionally, the UE may use UE assistance information (UAI) to update the applicability.

The RRCReconfigurationComplete IE may include various parameters for reporting applicability. For each serving cell configured with at least one reportConfigId associated with a CSI-ReportConfig including a configuration for measurement predictions, the UE 104 may include an entry in an applicabilityReportList parameter and specify content of the applicabilityReportList parameter. For example, the UE 104 may set an applicabilityCellId parameter to a serving cell index of the cell. Additionally, or alternatively, for each configured reportConfigId associated with a CSI-ReportConfig including a configuration for measurement predictions, the UE 104 may include an entry in the applicabilityReportConfigIdList parameter and set an applicabilityReportConfigId parameter to a the corresponding reportConfigId, set an applicabilityStatus parameter to the applicability status of the configuration for measurement predictions corresponding to the applicabilityReportConfigId, and if the applicabilityStatus parameter is set to inapplicable, set an inapplicabilityClause parameter for the configuration for measurement predictions to the cause of inapplicability.

In the RRCReconfigurationComplete IE, the applicabilityReportList parameter may indicate applicability reports related to the applicability of radio measurement prediction configurations. The applicabilityCellId parameter may indicate an index of the serving cell that an applicabilityReport refers to. The applicabilityReportConfigIdList parameter may indicate a list of applicability reports, each associated with a configuration ID for a configuration subject to the applicability determination procedure. The applicabilityReportConfigId parameter may indicate a CSI-ReportConfigId associated with a CSI report configured for radio measurement predictions. The applicabilityStatus parameter may indicate whether the CSI report configured for radio measurement predictions and associated with the applicabilityReportConfigId is applicable or inapplicable. The inapplicabilityCause parameter may indicate a cause due to which the CSI report configured for radio measurement predictions and associated with applicabilityReportConfigId is inapplicable. The applicabilityReportConfig parameter may indicate a configuration for the UE to indicate the applicability of configurations subject to the applicability determination procedure.

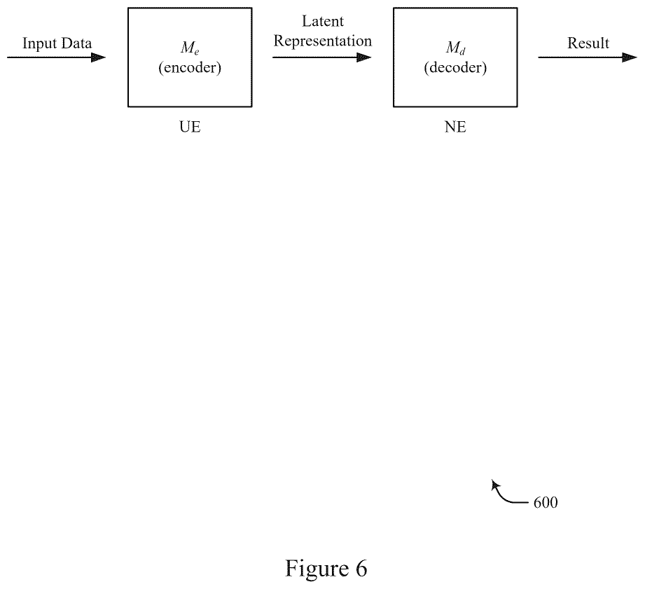

FIG. 6 illustrates an example of a model 600 in accordance with aspects of the present disclosure. In this example, the model 600 may be a two-sided model with a first part supported by a UE side and a second part supported by a NE side (e.g., a gNB, base station side). The UE side may be referred to as Mₑ, an encoding model or an encoder, and the NE side may be referred to as M_{d}, a decoding model or a decoder. The input data for the model 600 may be based on a channel measurement (e.g., a raw channel measurement) or eigenvectors associated with a measured channel. The UE side and the NE side of the model 600 may support AI-models, where the UE and the NE may be trained using the same AI-models or different AI-models.

The model 600 may support numerous two-sided model use cases, such as a CSI-compression use case. In some implementations, the model 600 may support relatively stable cases or settings. For example, the AI models supported by the UE and NE sides may be designed for different numbers of active receive and transmit antennas, or the models may be designed for different propagation conditions, A or B (e.g., indoor or outdoor). For example, such conditions may be referred to as C₁, C₂, . . . , C_{N}, where each of the Cᵢs may hold different states. For example,

$${C}_{1} ∈ \{ {c}_{1}^{1} , {c}_{1}^{2} , … , {c}_{1}^{{k}_{1}} \} and {C}_{i} ∈ \{ {c}_{i}^{1} , {c}_{i}^{2} , … , {c}_{i}^{{k}_{i}} \} .$$

Some other settings or cases may be more dynamic. For example, the AI models may be designed for generating feedback data based on a number of layers the UE is to send a report for, or designed to generate feedback data based on available processing units of UE battery conditions. For example, such dynamic conditions may be referred to as D₁, D₂, . . . , D_{M}, where each of the Dᵢs may hold different states. For example,

$${D}_{1} ∈ \{ {d}_{1}^{1} , {d}_{1}^{2} , … , {d}_{1}^{{k}_{1}} \} and {D}_{i} ∈ \{ {d}_{i}^{1} , {d}_{i}^{2} , … , {d}_{i}^{{k}_{i}} \} .$$

While AI models may be grouped based on stable or dynamic conditions, the techniques described herein are not limited to such grouping based on stable or dynamic conditions. As described herein, a set of conditions may be pre-determined such that a UE and an NE may coordinate and each select a model corresponding to the conditions. In some implementations, for a set of conditions that may not be pre-determined, the UE and the NE may select corresponding models only after performing some measurement.

In some examples, based on stable or dynamic conditions, the UE or the NE may change one part of the AI-model supported by the respective UE- or NE-side, in which case the other of the UE or the NE would also need to change a paired part of the AI-model supported by the respective other side. For example, if a number of reporting transmit ports changes the encoder at the UE-side, the decoder at the NE-side would also be modified accordingly. In another example, if the UE uses different encoder parts for encoding a precoder for a first layer than for the second layer, then the NE may also use a paired decoder model accordingly. This is in contrast with some conditions for which one side may support different models but all of the models are matched with a single model from the other side. For example, the same decoder model on the NE-side is paired with different encoder models on the UE-side). In this example, while the NE may use a single decoder model, the UE may use different encoder models when the UE has a low battery or a high battery, where both encoder models may be matched with the single decoder model.

In such cases, the UE and/or the NE may support multiple models, where each model may be trained or optimized for a particular configuration that is defined based on a combination of stable and dynamic conditions. That is, only one of the multiple models needs to be active at a given time. By way of example, a model M may be characterized by a tuple of conditions, such as

$${M}_{1} = ( {C}_{1} = {c}_{1}^{1} , {C}_{2} = {c}_{2}^{3} , {D}_{1} = {D}_{1}^{1} ) or {M}_{2} = ( {C}_{1} = {c}_{1}^{2} , {C}_{2} = {c}_{2}^{3} , {D}_{1} = {D}_{1}^{1} ) or {M}_{3} = ( {C}_{1} = {c}_{1}^{1} , {C}_{2} = {c}_{2}^{2} , {D}_{1} = {D}_{1}^{2} ) or {M}_{4} = ( {C}_{1} = {c}_{1}^{1} , {C}_{2} = {c}_{2}^{1} , {D}_{1} = {D}_{1}^{2} ) and {M}_{5} = ( {C}_{1} = {c}_{1}^{1} , {C}_{2} = {c}_{2}^{1} , {D}_{1} = {D}_{1}^{3} ) .$$

In this example, Cᵢ represents stable conditions and Dᵢ represents dynamic conditions, which may change during operation.

Some models may be differentiated using stable conditions, Cᵢs, for example, M₁ and M₂, or M₃ and M₄. However, some models may differ only based on the dynamic conditions, Dis, for example, M₁ and M₄, or M₁ and M₅. For example, M₁ may be trained for a case with eight transmit antennas used for sending information about a channel of rank 1, M₂ may be trained for a case with sixteen transmit antennas used for sending information about a channel of rank 1, and M₃ may be trained for a case with eight antennas used for sending information about a channel of rank 2. Different UE and NE nodes may have access to all or a few different models, however during inference, the UE-side (i.e., part 1) and the NE-side (i.e., part-2) of the model should match.

In some implementations of two-sided models, one side of the model for example, the NE-side, may ask the other side if the model, for example, the UE-side, about the availability of different models. Based on the response, the NE-side may activate one of the models for the inference and both the UE- and the NE-sides may use their respective part of the activated model. That is, the two sides may first exchange information about the availability of the models, and then one side (e.g., the NE-side) may configure the other side (e.g., the UE-model) to use a particular model for inference. After this configuration, the UE and the NE may use their respective parts of the AI-model. If there is a need to change the active model, the NE may reconfigure the UE. After such a reconfiguration, the UE and the NE may use their respective parts of the newly activated model.

In some scenarios, however, this approach may be inefficient as the NE may be unable to pre-select which model to be used during the inference. This may occur for models that are associated with the same stable conditions but different dynamic conditions. For example, if two models are used for reporting CSI information for channels with rank 1 and rank 2 (e.g., models M₁ and M₃ in the aforementioned example), the NE may lack sufficient information regarding which model to activate because selection of the model depends on the actual realization of the channel. Accordingly, the techniques described herein provide for alternative approaches where the UE and the NE sides may both agree on more than one model which may be used during inference, and the UE may select the model it will use for calculation of current feedback.

A UE may report data (e.g., feedback data, measurement data, and so forth) to an NE based on one of multiple reporting types (e.g., reporting schemes), such as a periodic reporting type, an aperiodic reporting type, or a semi-persistent reporting type. For the periodic reporting type, the NE may configure the UE to report a metric according to a particular period (i.e., periodic reporting). For the aperiodic reporting type, the NE may transmit a query message to the UE whenever the NE wants the UE to transmit measurement data. For the semi-persistent reporting type, the NE may preconfigure one or more reporting configurations, for example, with different periodicities. The NE may activate or deactivate such reporting configurations when the NE wants a particular setting by transmitting a message requesting that the UE start or stop transmitting messages to the NE based on one of the reporting configurations. By way of example, the UE may report CQI, RI, and PMI in a CSI-compression use case. Due to the relatively large size of such feedback data, the NE may use an aperiodic reporting type for requesting the UE to send the CSI data, however the selection of the reporting type may be use-case dependent, and the proposed scheme may be extended to any the reporting types.

In some implementations, a set or group of models Sₐ may represent models which are available at the UE and the NE. Based on some constraints, for example, stable constraints such as a number of transmit antennas, the NE may determine a set or group of models S_{b} which is a subset of Sₐ, and where the models in S_{b} represent the models among which the UE may select a model to activate. In some examples, S_{b} may include models that have the same stable conditions but different dynamic conditions. For example, S_{b} may include models associated with a specific number of transmit antennas but for channels of rank 1 and rank 2. In some examples, the NE may transmit configuration messages to the UE for a set or group of models St, where the models in Sₜ include the models that the NE supports. Then, the UE may indicate which of the models from Sₜ are also supported by (available at) the UE. Such models may be included in a set of models Sₐ.

In some implementations, each trained model (e.g., each model trained for a particular set of stable and dynamic conditions) may be associated with an ID, such as a pairing ID. The NE may transmit separate configuration messages for each of the models in the set S_{b}. In some cases, the NE May transmit different CSI-ReportConfigs with different reportConfigIds, where each CSI-ReportConfig may indicate one of the models in S_{b}, for example, by indicating an ID corresponding to that model. As described in FIGS. 4A through 4H, a CSI-ReportConfig IE may be used to configure other parameters for CSI reporting such as reportQuantity, reportConfigType, reportSlotOffsetList in the case of aperiodic reporting, or CSI-ReportPeriodicityAndOffset in the case of periodic or semi-persistent reporting.

For all models in the set S_{b}, the corresponding CSI-ReportConfig IE may also include other information that directly or indirectly indicates that these models are related to the same S_{b}. For example, the CSI-ReportConfig IE may include a parameter report-group-Id, or there may be a pattern in the corresponding painting ID that indicates the models are in the same S_{b}. Using such information, the UE may understand that it is to select one of these models and transmit a response back to the NE based on the selected model. In this way, instead of the UE transmitting a report for every received configuration message, there is no need for the UE to transmit a report for each of the configurations associated with each model in the same S_{b}. The NE may use the decoder (e.g., part 2 of the model) to decode the report to know which model the UE used to generate the feedback data. As the report may include a reportConfigId parameter that the UE used for generation of the feedback data, where the UE may select the reportConfigId parameter from a set of reportConfigId parameters received from the NE, the NE may determine such information based on the reportConfigId parameter. In some implementations, parameters such as reportSlotOffsetList and reportPeriodicityAndOffset for all of the CSI-ReportConfig IEs may be set similarly, as only one of each of these parameters may be activated and transmitted on the same uplink resources.

By way of example, the NE may configure two reports. A first report configuration may be for a set of models S_{b1}, which may include models M₁ and M₅, and the second report configuration may be for a set of models S_{b2}, which may include models M₆ and M₇. For these two sets, the NE may transmit the following CSI-ReportConfig IEs: one CSI-ReportConfig IE with reportConfigId=1 and referring to an ID of M₁ and report-group-Id=1, one CSI-ReportConfig IE with reportConfigId=2 and referring to an ID of M₅ and report-group-Id=1, one CSI-ReportConfig IE with reportConfigId=3 and referring to an ID of M₆ and report-group-Id=2, and one CSI-ReportConfig IE with reportConfigId=4 and referring to an ID of M₇ and report-group-Id=2.

In cases where a length of resources (e.g., number of resources) needed for CSI reporting is different for models within the same S_{b}, the NE may assign uplink resources that support the model within S_{b} that requires the largest feedback rate. Additionally, before transmitting the actual CSI report, the UE may transmit a length (e.g., number of resources) of the CSI reports, for example, by transmitting a field that indicates the size of the CSI reports. In this way, the UE may use extra assigned uplink REs if the required feedback rate of a model within S_{b} is less than the number of uplink resources assigned by the NE. In some implementation, the UE may use the extra REs to transmit user data (e.g., UE data). The NE, using the receive length of the report, may also know which part of the message (e.g., which resources) is used for CSI data and which part is used for the user data. In some implementations, the NE may determine the length of the CSI report based on the model the UE used for reporting, as indicated in the reportConfigId field. In such cases, the UE may refrain from separately transmitting a field indicating a length of the report.

In some examples, the NE may transmit separate configuration messages (e.g., CSI-ReportConfig IEs) for each model in the set of models S_{b}. In such cases, the NE may already know S_{b} and the included models. Alternatively, the NE may transmit configuration messages (e.g., CSI-ReportConfig IEs) for each model in the set of models St. In such cases, as described herein, the NE may include an indication for the model associated with a given configuration message and also include an indication of a group with which the model is associated. The UE may then report which of these models are applicable (e.g., available), and the NE may activate one group of models associated with the same S_{b}.

Alternatively, instead of transmitting separate configuration message for each model in one set S_{b}, the NE may transmit one configuration (e.g., one CSI-ReportConfig IE) that indicates the IDs of every model in the set S_{b}. The UE may indicate applicability of the configuration only if all of the models in the set S_{b} are available (e.g., applicable). During the reporting. the UE may select the appropriate model among the list of models in the configuration and use that model to generate the report. The UE may indicate which model it used to generate the report, for example, by including an ID corresponding to the model in the report. Based on this indication, the NE may determine which part of its model to use. In some implementations, the number of resources the NE assigns for the report may support the largest feedback rate from all the models indicated in the configuration. As the UE may actually use fewer resources than the number of the assigned uplink resources based on the model the UE uses, the UE may also indicate the length of the resources (e.g., number of resources) used to transmit the report. In such cases, the UE may use the extra REs (not used to transmit the report) to transmit other data (e.g., user data). As such, using the received indication of the length of the report, the UE may also know which resources are used for CSI report data and which are used for the other data (e.g., user data). In some implementations, the UE may determine the length of the report based on the ID of the model included in the report. In such cases, the UE may refrain from separately transmitting an indication of the length of the report.

Instead of assigning an ID (e.g., a pairing ID) to each trained model, the ID may be assigned to a group of trained models that the UE may select among for generation of the report. For example, the ID may be assigned to a set of models in one S_{b}. That is, one ID may be assigned to all models that have similar stable conditions but different dynamic conditions. For example, models M₁ and M₃ may have the same pairing ID, where both models may support eight transmit antennas but may be used for different ranks (e.g., rank 1 and rank 2). In another example, models M₁ and M₂ may have different pairing IDs because the models have different stable conditions. That is, if two models have the same stable conditions, there is no need for the UE to select which model to use after receiving the configuration and during reporting.

During reporting, based on the ID indicated in the configuration (where the ID is assigned to a group of models, S_{b}), the UE may know which models are acceptable (available) for use and select the model that is best suited for current conditions. For example, the UE may select between the model M₁ and the model M₃ based on the rank of the measured channel. Other than the actual CSI report, the UE may indicate which of the models it has used to generate the report so the NE may determine which corresponding part of its model to use. In some implementations, each of the models in one set of models (e.g., S_{b}) may be assigned different ID (known for both the UE and the NE). The UE may use the IDs to indicate to the NE which model it used to generate the report. In some cases, the UE may indicate the model indirectly based on another message it transmitted to the NE. For instance, if the UE separately reports the rank (e.g., using an RI) of a channel to the NE, then the NE can use the information to determine which of the models the UE to used to generate the report and subsequently determine which part of its model to use.

In some implementations, the ID assigned to a trained model may have two parts. A first part of the ID may be common between all of the models in one set (e.g., all the models in one S_{b}) and the second part of the ID may represent the individual models in one S_{b}. With such ID assignments, the NE may transmit one configuration (e.g., one CSI-ReportConfig IE), where the configuration may indicate the first part of the ID that is assigned to that set of models, S_{b}. During reporting, based on the indicated first part of the ID, the UE may know which model it may use and then select the model that is best suited for the current condition. Other than the actual report, the UE may indicate which of the models it used to generate the report so the NE can determine which part of its model to use. For this indication, the UE may use the second part of the model ID.

Similar to the first ID assignment procedure, in some implementations, the number of uplink resources that the NE assigns for the report should support the largest feedback rate from the models indicated in the configuration (e.g., all the models that are associated with the configured ID, which are in the same set S_{b}). As the UE may need fewer resources than the number of resources assigned by the NE based on the model the UE selects for reporting, the UE may also indicate the length of the resources (e.g., number of resources) it used for a particular report and use the extra resources (not used for transmitting the report) to send other data (e.g., user data). The NE, using the received length of the report, may also know which part the UE used for the CSI report data and which part the UE used for the other data (e.g., user data). In some implementations, the UE may refrain from sending the length (e.g., number of resources) it used for transmitting each particular report, and the NE may determine the length of the reported message based on the indication of the models it used to generate the model (e.g., ID of the model in the set S_{b}), other information such as the RI that may be used for model determination, or the second part of the ID indicated by the UE in the report.

As described herein, a UE may be a node that has supports a first part (e.g., part 1) of a model (e.g., an encoder, an encoding model) that generates a latent representation. An NE may be a node that supports a second part (e.g., part 2) of the model (e.g., a decoder, a decoder model) and generates a final output. In some cases, some UEs may be capable of being configured with a set of models from which the UE may select an appropriate model to use during inference. In sch cases, the UE may directly or indirectly indicate such a capability in a message to the NE, for example, in a UE capability report.

In some cases, the difference between two models may be based on a quantization scheme associated with each model, where the quantization scheme may be scalar quantization, vector quantization, or a quantization codebook of a vector quantization scheme. As such, coordination between the two nodes on which the model is used may be equivalent to which quantizer, de-quantizer, or quantization codebook is used or a combination of which model and which quantization scheme should be used.

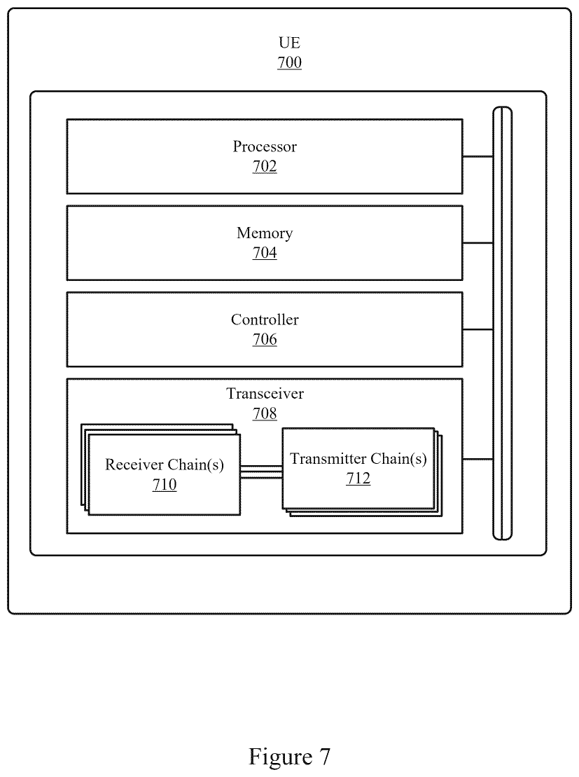

FIG. 7 illustrates an example of a UE 700 in accordance with aspects of the present disclosure. The UE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the UE 700 to perform various functions of the present disclosure.

The memory 704 may include volatile or non-volatile memory. The memory 704 may store computer-readable, computer-executable code including instructions when executed by the processor 702 cause the UE 700 to perform various functions described herein. The code may be stored in a non-transitory computer-readable medium such as the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the UE 700 to perform one or more of the functions described herein (e.g., executing, by the processor 702, instructions stored in the memory 704). For example, the processor 702 may support wireless communication at the UE 700 in accordance with examples as disclosed herein. The UE 700 may be configured to or operable to support a means for receiving one or more parameter sets, wherein each parameter set comprises one or more parameters for measurement and a plurality of encoding procedures; selecting an encoding procedure of the plurality of encoding procedures based at least in part on measurements of the one or more parameters; and transmitting an indication of the selected encoding procedure.

Additionally, the UE 700 may be configured to support any one or combination of generating feedback data based at least in part on the measurements and the selected encoding procedure; receiving an indication of a set of resources; and transmitting the indication of the selected encoding procedure and the feedback data on at least one resource of the set of resources; where the set of resources is a same set of resources for multiple parameter sets; where a quantity of resources in the set of resources is based at least in part on a largest quantity of resources needed for transmission of the feedback data among the plurality of encoding procedures; transmitting an indication of a quantity of resources from the set of resources used for transmission of the feedback data; multiplexing the feedback data and other data for transmission on the set of resources; where a parameter set of the one or more parameter sets corresponds to an encoding procedure of the plurality of encoding procedures, and wherein the at least one processor is further operable to cause the UE to determine a group of encoding procedures that includes the encoding procedure based on an ID of the encoding procedure; where each encoding procedure of the plurality of encoding procedures corresponds to an ID, and wherein the indication of the selected encoding procedure comprises an ID corresponding to the selected encoding procedure; wherein a parameter set of the one or more parameter sets corresponds to an encoding procedure of the plurality of encoding procedures, and wherein the parameter set further comprises a field that indicates a group of encoding procedures that includes the encoding procedure; wherein the one or more parameter sets comprises one parameter set that indicates the plurality of encoding procedures; selecting the encoding procedure based at least in part on a determination of one or more parameters excluded from the one or more parameter sets; or where each encoding procedure of the plurality of encoding procedures represent an NN-based model or a quantization scheme.

Additionally, or alternatively, the UE 700 may support at least one memory (e.g., the memory 704) and at least one processor (e.g., the processor 702) coupled with the at least one memory and configured to cause the UE to receive one or more parameter sets, wherein each parameter set comprises one or more parameters for measurement and a plurality of encoding procedures; selecting an encoding procedure of the plurality of encoding procedures based at least in part on measurements of the one or more parameters; and transmitting an indication of the selected encoding procedure.

Additionally, the UE 700 may be configured to support any one or combination of generating feedback data based at least in part on the measurements and the selected encoding procedure; receiving an indication of a set of resources; and transmitting the indication of the selected encoding procedure and the feedback data on at least one resource of the set of resources; where the set of resources is a same set of resources for multiple parameter sets; where a quantity of resources in the set of resources is based at least in part on a largest quantity of resources needed for transmission of the feedback data among the plurality of encoding procedures; transmitting an indication of a quantity of resources from the set of resources used for transmission of the feedback data; multiplexing the feedback data and other data for transmission on the set of resources; where a parameter set of the one or more parameter sets corresponds to an encoding procedure of the plurality of encoding procedures, and wherein the at least one processor is further operable to cause the UE to determine a group of encoding procedures that includes the encoding procedure based on an ID of the encoding procedure; where each encoding procedure of the plurality of encoding procedures corresponds to an ID, and wherein the indication of the selected encoding procedure comprises an ID corresponding to the selected encoding procedure; wherein a parameter set of the one or more parameter sets corresponds to an encoding procedure of the plurality of encoding procedures, and wherein the parameter set further comprises a field that indicates a group of encoding procedures that includes the encoding procedure; wherein the one or more parameter sets comprises one parameter set that indicates the plurality of encoding procedures; selecting the encoding procedure based at least in part on a determination of one or more parameters excluded from the one or more parameter sets; or where each encoding procedure of the plurality of encoding procedures represent an NN-based model or a quantization scheme.

The controller 706 may manage input and output signals for the UE 700. The controller 706 may also manage peripherals not integrated into the UE 700. In some implementations, the controller 706 may utilize an operating system such as iOS®, ANDROID®, WINDOWS®, or other operating systems. In some implementations, the controller 706 may be implemented as part of the processor 702.

In some implementations, the UE 700 may include at least one transceiver 708. In some other implementations, the UE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas to receive a signal over the air or wireless medium. The receiver chain 710 may include at least one amplifier (e.g., a low-noise amplifier (LNA)) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

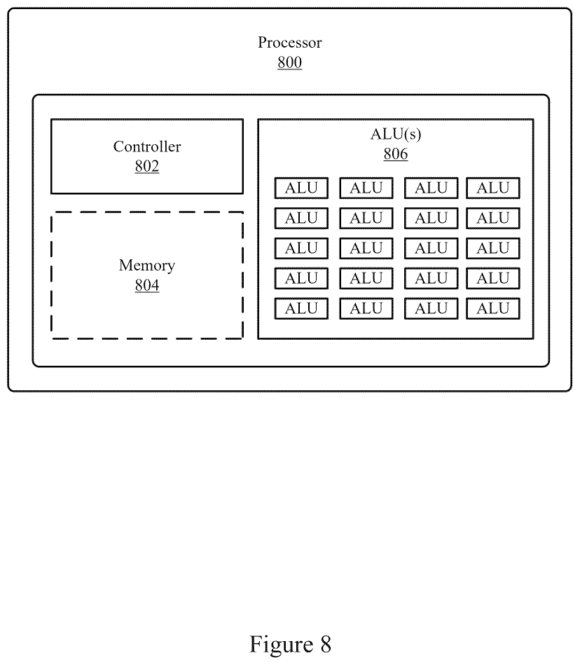

FIG. 8 illustrates an example of a processor 800 in accordance with aspects of the present disclosure. The processor 800 may be an example of a processor configured to perform various operations in accordance with examples as described herein. The processor 800 may include a controller 802 configured to perform various operations in accordance with examples as described herein. The processor 800 may optionally include at least one memory 804, which may be, for example, an L1/L2/L3 cache. Additionally, or alternatively, the processor 800 may optionally include one or more arithmetic-logic units (ALUs) 806. One or more of these components may be in electronic communication or otherwise coupled (e.g., operatively, communicatively, functionally, electronically, electrically) via one or more interfaces (e.g., buses).

The processor 800 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 800) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 802 may be configured to manage and coordinate various operations (e.g., signaling, receiving, obtaining, retrieving, transmitting, outputting, forwarding, storing, determining, identifying, accessing, writing, reading) of the processor 800 to cause the processor 800 to support various operations in accordance with examples as described herein. For example, the controller 802 may operate as a control unit of the processor 800, generating control signals that manage the operation of various components of the processor 800. These control signals include enabling or disabling functional units, selecting data paths, initiating memory access, and coordinating timing of operations.

The controller 802 may be configured to fetch (e.g., obtain, retrieve, receive) instructions from the memory 804 and determine subsequent instruction(s) to be executed to cause the processor 800 to support various operations in accordance with examples as described herein. The controller 802 may be configured to track memory addresses of instructions associated with the memory 804. The controller 802 may be configured to decode instructions to determine the operation to be performed and the operands involved. For example, the controller 802 may be configured to interpret the instruction and determine control signals to be output to other components of the processor 800 to cause the processor 800 to support various operations in accordance with examples as described herein. Additionally, or alternatively, the controller 802 may be configured to manage flow of data within the processor 800. The controller 802 may be configured to control transfer of data between registers, ALUs 806, and other functional units of the processor 800.

The memory 804 may include one or more caches (e.g., memory local to or included in the processor 800 or other memory, such as RAM, ROM, DRAM, SDRAM, SRAM, MRAM, flash memory, etc. In some implementations, the memory 804 may reside within or on a processor chipset (e.g., local to the processor 800). In some other implementations, the memory 804 may reside external to the processor chipset (e.g., remote to the processor 800).

The memory 804 may store computer-readable, computer-executable code including instructions that, when executed by the processor 800, cause the processor 800 to perform various functions described herein. The code may be stored in a non-transitory computer-readable medium such as system memory or another type of memory. The controller 802 and/or the processor 800 may be configured to execute computer-readable instructions stored in the memory 804 to cause the processor 800 to perform various functions. For example, the processor 800 and/or the controller 802 may be coupled with or to the memory 804, the processor 800, and the controller 802, and may be configured to perform various functions described herein. In some examples, the processor 800 may include multiple processors and the memory 804 may include multiple memories. One or more of the multiple processors may be coupled with one or more of the multiple memories, which may, individually or collectively, be configured to perform various functions herein.

The one or more ALUs 806 may be configured to support various operations in accordance with examples as described herein. In some implementations, the one or more ALUs 806 may reside within or on a processor chipset (e.g., the processor 800). In some other implementations, the one or more ALUs 806 may reside external to the processor chipset (e.g., the processor 800). One or more ALUs 806 may perform one or more computations such as addition, subtraction, multiplication, and division on data. For example, one or more ALUs 806 may receive input operands and an operation code, which determines an operation to be executed. One or more ALUs 806 may be configured with a variety of logical and arithmetic circuits, including adders, subtractors, shifters, and logic gates, to process and manipulate the data according to the operation. Additionally, or alternatively, the one or more ALUs 806 may support logical operations such as AND, OR, exclusive-OR (XOR), not-OR (NOR), and not-AND (NAND), enabling the one or more ALUs 806 to handle conditional operations, comparisons, and bitwise operations.

The processor 800 may support wireless communication in accordance with examples as disclosed herein. The processor 800 may be configured to or operable to support at least one controller (e.g., the controller 802) coupled with at least one memory (e.g., the memory 804) and configured to cause the processor to receive one or more parameter sets, wherein each parameter set comprises one or more parameters for measurement and a plurality of encoding procedures; selecting an encoding procedure of the plurality of encoding procedures based at least in part on measurements of the one or more parameters; and transmitting an indication of the selected encoding procedure.

Additionally, the processor 800 may be configured to or operable to support any one or combination of generating feedback data based at least in part on the measurements and the selected encoding procedure; receiving an indication of a set of resources; and transmitting the indication of the selected encoding procedure and the feedback data on at least one resource of the set of resources; where the set of resources is a same set of resources for multiple parameter sets; where a quantity of resources in the set of resources is based at least in part on a largest quantity of resources needed for transmission of the feedback data among the plurality of encoding procedures; transmitting an indication of a quantity of resources from the set of resources used for transmission of the feedback data; multiplexing the feedback data and other data for transmission on the set of resources; where a parameter set of the one or more parameter sets corresponds to an encoding procedure of the plurality of encoding procedures, and wherein the at least one processor is further operable to cause the UE to determine a group of encoding procedures that includes the encoding procedure based on an ID of the encoding procedure; where each encoding procedure of the plurality of encoding procedures corresponds to an ID, and wherein the indication of the selected encoding procedure comprises an ID corresponding to the selected encoding procedure; wherein a parameter set of the one or more parameter sets corresponds to an encoding procedure of the plurality of encoding procedures, and wherein the parameter set further comprises a field that indicates a group of encoding procedures that includes the encoding procedure; wherein the one or more parameter sets comprises one parameter set that indicates the plurality of encoding procedures; selecting the encoding procedure based at least in part on a determination of one or more parameters excluded from the one or more parameter sets; or where each encoding procedure of the plurality of encoding procedures represent an NN-based model or a quantization scheme.

Additionally, or alternatively, the processor 800 may support wireless communication in accordance with examples as disclosed herein. The processor 800 may be configured to or operable to support at least one controller (e.g., the controller 802) coupled with at least one memory (e.g., the memory 804) and configured to cause the processor to transmit one or more parameter sets, wherein each parameter set comprises one or more parameters for measurement by a UE and a plurality of encoding procedures; receive an indication of a selected encoding procedure of the plurality of encoding procedures; and determine a decoding procedure based at least in part on the selected encoding procedure.

Additionally, or alternatively, the processor 800 may be configured to or operable to support any one or combination of transmitting an indication of a set of resources; receiving the indication of the selected encoding procedure and feedback data on at least one resource of the set of resources; and decoding the feedback data based at least in part on the decoding procedure; wherein the set of resources is a same set of resources for multiple parameter sets; wherein a quantity of resources in the set of resources is based at least in part on a largest quantity of resources needed for transmission of the feedback data among the plurality of encoding procedures; receiving an indication of a quantity of resources from the set of resources used for transmission of the feedback data; de-multiplexing the feedback data and other data received on the set of resources based on the quantity of resources; wherein each encoding procedure of the plurality of encoding procedures represent a NN-based model or a quantization scheme; wherein a parameter set of the one or more parameter sets corresponds to an encoding procedure of the plurality of encoding procedures and wherein a group of encoding procedures that includes the encoding procedure is indicated based on an ID of the encoding procedure; wherein each encoding procedure of the plurality of encoding procedures corresponds to an ID, and wherein the indication of the selected encoding procedure comprises an ID corresponding to the selected encoding procedure; wherein a parameter set of the one or more parameter sets corresponds to an encoding procedure of the plurality of encoding procedures, and wherein the parameter set further comprises a field that indicates a group of encoding procedures that includes the encoding procedure; or wherein the one or more parameter sets comprises one parameter set that indicates the plurality of encoding procedures.

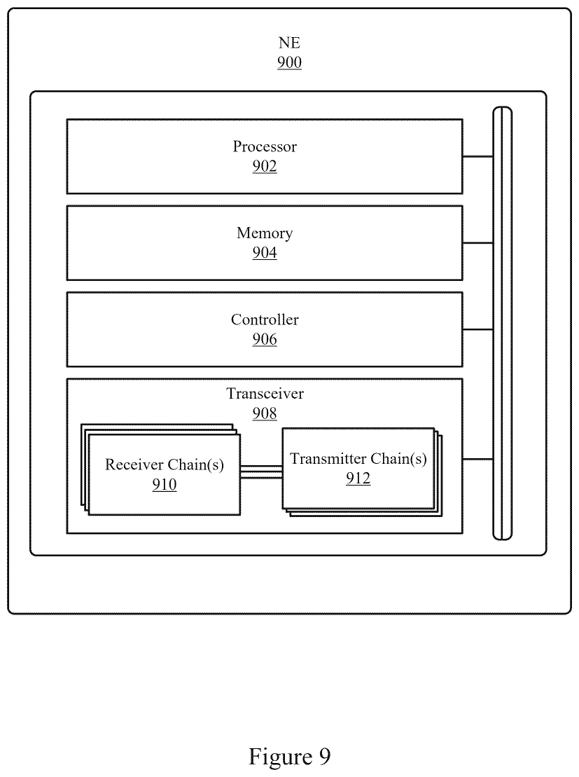

FIG. 9 illustrates an example of an NE 900 in accordance with aspects of the present disclosure. The NE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a CPU, an ASIC, an FPGA, or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the NE 900 to perform various functions of the present disclosure.

The memory 904 may include volatile or non-volatile memory. The memory 904 may store computer-readable, computer-executable code including instructions when executed by the processor 902 cause the NE 900 to perform various functions described herein. The code may be stored in a non-transitory computer-readable medium such as the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the NE 900 to perform one or more of the functions described herein (e.g., executing, by the processor 902, instructions stored in the memory 904). For example, the processor 902 may support wireless communication at the NE 900 in accordance with examples as disclosed herein. The NE 900 may be configured to or operable to support a means for transmitting one or more parameter sets, wherein each parameter set comprises one or more parameters for measurement by a UE and a plurality of encoding procedures; receiving an indication of a selected encoding procedure of the plurality of encoding procedures; and determining a decoding procedure based at least in part on the selected encoding procedure.

Additionally, the NE 900 may be configured to or operable to support any one or combination of transmitting an indication of a set of resources; receiving the indication of the selected encoding procedure and feedback data on at least one resource of the set of resources; and decoding the feedback data based at least in part on the decoding procedure; wherein the set of resources is a same set of resources for multiple parameter sets; wherein a quantity of resources in the set of resources is based at least in part on a largest quantity of resources needed for transmission of the feedback data among the plurality of encoding procedures; receiving an indication of a quantity of resources from the set of resources used for transmission of the feedback data; de-multiplexing the feedback data and other data received on the set of resources based on the quantity of resources; wherein each encoding procedure of the plurality of encoding procedures represent a NN-based model or a quantization scheme; wherein a parameter set of the one or more parameter sets corresponds to an encoding procedure of the plurality of encoding procedures and wherein a group of encoding procedures that includes the encoding procedure is indicated based on an ID of the encoding procedure; wherein each encoding procedure of the plurality of encoding procedures corresponds to an ID, and wherein the indication of the selected encoding procedure comprises an ID corresponding to the selected encoding procedure; wherein a parameter set of the one or more parameter sets corresponds to an encoding procedure of the plurality of encoding procedures, and wherein the parameter set further comprises a field that indicates a group of encoding procedures that includes the encoding procedure; or wherein the one or more parameter sets comprises one parameter set that indicates the plurality of encoding procedures.

Additionally, or alternatively, the NE 900 may support at least one memory (e.g., the memory 904) and at least one processor (e.g., the processor 902) coupled with the at least one memory and configured to cause the NE to transmit one or more parameter sets, wherein each parameter set comprises one or more parameters for measurement by a UE and a plurality of encoding procedures; receive an indication of a selected encoding procedure of the plurality of encoding procedures; and determine a decoding procedure based at least in part on the selected encoding procedure.

Additionally, the NE 900 may be configured to support any one or combination of transmitting an indication of a set of resources; receiving the indication of the selected encoding procedure and feedback data on at least one resource of the set of resources; and decoding the feedback data based at least in part on the decoding procedure; wherein the set of resources is a same set of resources for multiple parameter sets; wherein a quantity of resources in the set of resources is based at least in part on a largest quantity of resources needed for transmission of the feedback data among the plurality of encoding procedures; receiving an indication of a quantity of resources from the set of resources used for transmission of the feedback data; de-multiplexing the feedback data and other data received on the set of resources based on the quantity of resources; wherein each encoding procedure of the plurality of encoding procedures represent a NN-based model or a quantization scheme; wherein a parameter set of the one or more parameter sets corresponds to an encoding procedure of the plurality of encoding procedures and wherein a group of encoding procedures that includes the encoding procedure is indicated based on an ID of the encoding procedure; wherein each encoding procedure of the plurality of encoding procedures corresponds to an ID, and wherein the indication of the selected encoding procedure comprises an ID corresponding to the selected encoding procedure; wherein a parameter set of the one or more parameter sets corresponds to an encoding procedure of the plurality of encoding procedures, and wherein the parameter set further comprises a field that indicates a group of encoding procedures that includes the encoding procedure; or wherein the one or more parameter sets comprises one parameter set that indicates the plurality of encoding procedures.

The controller 906 may manage input and output signals for the NE 900. The controller 906 may also manage peripherals not integrated into the NE 900. In some implementations, the controller 906 may utilize an operating system such as iOS®, ANDROID®, WINDOWS®, or other operating systems. In some implementations, the controller 906 may be implemented as part of the processor 902.

In some implementations, the NE 900 may include at least one transceiver 908. In some other implementations, the NE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas to receive a signal over the air or wireless medium. The receiver chain 910 may include at least one amplifier (e.g., a low-noise amplifier (LNA)) configured to amplify the received signal. The receiver chain 910 may include at least one demodulator configured to demodulate the receive signal and obtain the transmitted data by reversing the modulation technique applied during transmission of the signal. The receiver chain 910 may include at least one decoder for decoding the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

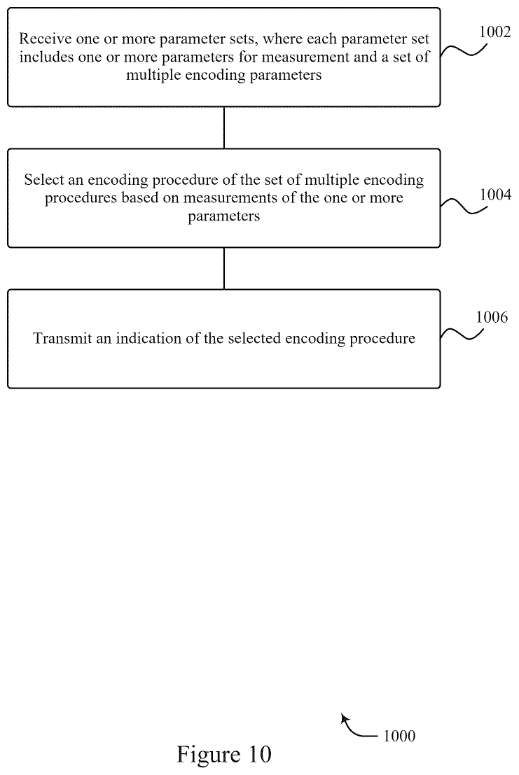

FIG. 10 illustrates a flowchart of a method 1000 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1002, the method may include receiving one or more parameter sets, wherein each parameter set comprises one or more parameters for measurement and a plurality of encoding procedures. The operations of 1002 may be performed in accordance with examples as described herein. In some implementations, aspects of the operations of 1002 may be performed by a UE as described with reference to FIG. 7.

At 1004, the method may include selecting an encoding procedure of the plurality of encoding procedures based at least in part on measurements of the one or more parameters. The operations of 1004 may be performed in accordance with examples as described herein. In some implementations, aspects of the operations of 1004 may be performed by a UE as described with reference to FIG. 7.

At 1006, the method may include transmitting an indication of the selected encoding procedure. The operations of 1006 may be performed in accordance with examples as described herein. In some implementations, aspects of the operations of 1006 may be performed a UE as described with reference to FIG. 7.

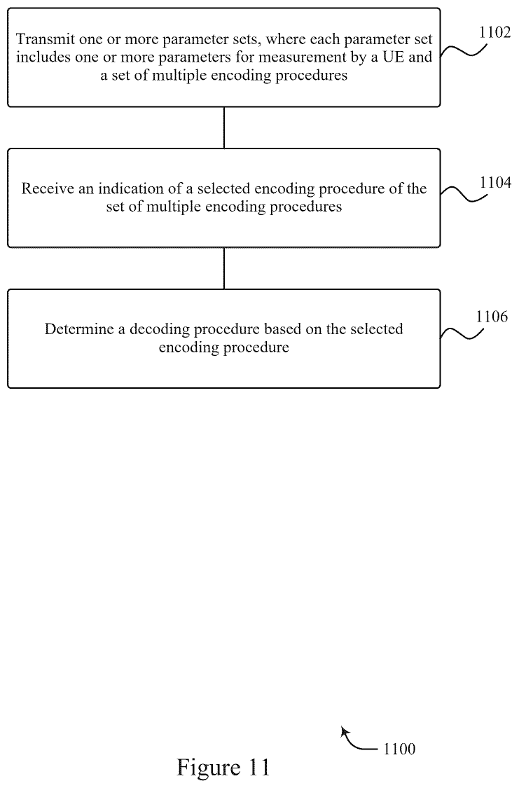

FIG. 11 illustrates a flowchart of a method 1100 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1102, the method may include transmitting one or more parameter sets, wherein each parameter set comprises one or more parameters for measurement by a UE and a plurality of encoding procedures. The operations of 1102 may be performed in accordance with examples as described herein. In some implementations, aspects of the operations of 1102 may be performed by an NE as described with reference to FIG. 9.

At 1104, the method may include receiving an indication of a selected encoding procedure of the plurality of encoding procedures. The operations of 1104 may be performed in accordance with examples as described herein. In some implementations, aspects of the operations of 1104 may be performed by an NE as described with reference to FIG. 9.

At 1106, the method may include determining a decoding procedure based at least in part on the selected encoding procedure. The operations of 1106 may be performed in accordance with examples as described herein. In some implementations, aspects of the operations of 1106 may be performed an NE as described with reference to FIG. 9.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive one or more parameter sets, wherein each parameter set comprises one or more parameters for measurement and a plurality of encoding procedures;
select an encoding procedure of the plurality of encoding procedures based at least in part on measurements of the one or more parameters; and
transmit an indication of the selected encoding procedure.

2. The UE of claim 1, wherein the at least one processor is further operable to cause the UE to generate feedback data based at least in part on the measurements and the selected encoding procedure.

3. The UE of claim 2, wherein the at least one memory is further operable to cause the UE to:
receive an indication of a set of resources; and
transmit the indication of the selected encoding procedure and the feedback data on at least one resource of the set of resources.

4. The UE of claim 3, wherein the set of resources is a same set of resources for multiple parameter sets.

5. The UE of claim 3, wherein a quantity of resources in the set of resources is based at least in part on a largest quantity of resources needed for transmission of the feedback data among the plurality of encoding procedures.

6. The UE of claim 3, wherein the at least one processor is further operable to cause the UE to transmit an indication of a quantity of resources from the set of resources used for transmission of the feedback data.

7. The UE of claim 3, wherein the at least one processor is further operable to cause the UE to multiplex the feedback data and other data for transmission on the set of resources.

8. The UE of claim 1, wherein a parameter set of the one or more parameter sets corresponds to an encoding procedure of the plurality of encoding procedures, and wherein the at least one processor is further operable to cause the UE to determine a group of encoding procedures that includes the encoding procedure based on an identifier (ID) of the encoding procedure.

9. The UE of claim 1, wherein each encoding procedure of the plurality of encoding procedures corresponds to an identifier (ID), and wherein the indication of the selected encoding procedure comprises an ID corresponding to the selected encoding procedure.

10. The UE of claim 1, wherein a parameter set of the one or more parameter sets corresponds to an encoding procedure of the plurality of encoding procedures, and wherein the parameter set further comprises a field that indicates a group of encoding procedures that includes the encoding procedure.

11. The UE of claim 1, wherein the one or more parameter sets comprises one parameter set that indicates the plurality of encoding procedures.

12. The UE of claim 1, wherein the encoding procedure is selected based at least in part on a determination of one or more parameters excluded from the one or more parameter sets.

13. The UE of claim 1, wherein each encoding procedure of the plurality of encoding procedures represent a neural network (NN)-based model or a quantization scheme.

14. A network equipment (NE) for wireless communication, comprising:
at least one memory; and
at least one processor coupled with the at least one memory and operable to cause the NE to:
transmit one or more parameter sets, wherein each parameter set comprises one or more parameters for measurement by a user equipment (UE) and a plurality of encoding procedures;
receive an indication of a selected encoding procedure of the plurality of encoding procedures; and
determine a decoding procedure based at least in part on the selected encoding procedure.

15. The NE of claim 14, wherein the at least one memory is further operable to cause the NE to:
transmit an indication of a set of resources;
receive the indication of the selected encoding procedure and feedback data on at least one resource of the set of resources; and
decode the feedback data based at least in part on the decoding procedure.

16. The NE of claim 15, wherein the set of resources is a same set of resources for multiple parameter sets.

17. The NE of claim 15, wherein a quantity of resources in the set of resources is based at least in part on a largest quantity of resources needed for transmission of the feedback data among the plurality of encoding procedures.

18. The NE of claim 15, wherein the at least one processor is further operable to cause the NE to receive an indication of a quantity of resources from the set of resources used for transmission of the feedback data.

19. A method performed by a user equipment (UE), comprising:
receiving one or more parameter sets, wherein each parameter set comprises one or more parameters for measurement and a plurality of encoding procedures;
selecting an encoding procedure of the plurality of encoding procedures based at least in part on measurements of the one or more parameters; and
transmitting an indication of the selected encoding procedure.

20. A method performed by a network equipment (NE), comprising:
transmitting one or more parameter sets, wherein each parameter set comprises one or more parameters for measurement by a user equipment (UE) and a plurality of encoding procedures;
receiving an indication of a selected encoding procedure of the plurality of encoding procedures; and
determining a decoding procedure based at least in part on the selected encoding procedure.
